(19) United States
(12) Patent Application Publication
(10) Pub. No.: US 2016/0319787 A1
(43) Pub. Date: Nov. 3, 2016

(54) FUEL DISTRIBUTION/SUPPLY DEVICE

(71) Applicant: SANOH INDUSTRIAL CO., LTD., Tokyo (JP)

(72) Inventors: Kohei UDAGAWA, Koga-shi, Ibaraki (JP); Masakazu NOMURA, Koga-shi, Ibaraki (JP)

(21) Appl. No.: 15/105,540

(22) PCT Filed: Oct. 31, 2014
(86) PCT No.: PCT/JP2014/079126

§ 371 Date: Jun. 16, 2016

(30) Foreign Application Priority Data
Dec. 20, 2013 (JP) 2013-263932

(51) Int. Cl. F02M 55/02; F02M 69/46; F02M 55/00

(52) U.S. Cl. CPC F02M 55/025; F02M 55/005; F02M 69/465

(57) ABSTRACT

A fuel distribution/supply device includes a high-pressure fuel storage portion (5) which stores a fuel in a high-pressure state in order to supply the fuel to a plurality of fuel injection devices (4) and a plurality of cup portions (6) which airtightly keeps each fuel injection device (4) and supplies the fuel stored in the high-pressure fuel storage portion (5) to each fuel injection device (4), the cup portion (6) includes a seal portion (13) which is provided with an airtight keeping surface (10) airtightly keeping each fuel injection device (4) and a cup body (14) which is bonded to the high-pressure fuel storage portion (5) and is provided with a seal portion insertion hole (18) being inserted with the seal portion (13), and the seal portion (13) and the cup body (14) are formed as separate members and are bonded to each other.

### TECHNICAL FIELD

The present invention relates to a fuel distribution/supply device which distributes and supplies a fuel to a plurality of fuel injection devices.

### BACKGROUND ART

Patent Literature 1 discloses a fuel distribution/supply device which distributes and supplies a high-pressure fuel to each fuel injection device injecting a fuel to each cylinder of a direct injection engine. The fuel distribution/supply device includes a high-pressure fuel storage portion (described as a main fuel supply pipe in Patent Literature 1) which extends linearly and stores a fuel in a high-pressure state and a plurality of cup portions which supplies the high-pressure fuel stored in the high-pressure fuel storage portion to each fuel injection device. Each cup portion is formed as a single component and an inner peripheral surface of each cup portion is formed as an airtight keeping surface airtightly keeping each fuel injection device.

### CITATION LIST

### Patent Literature

Patent Literature 1: Japanese Unexamined Patent Publication No. 2003-106273

Patent Literature 2: Japanese Unexamined Patent Publication No. 2003-343463

### SUMMARY OF INVENTION

### Technical Problem

Incidentally, the airtight keeping surface needs to have high dimensional precision involved with a hole diameter, a roughness, a roundness, and the like in order to keep the airtightness with respect to the fuel injection device. Particularly, since the fuel pressure is set to high in a direct injection engine, the dimension of the airtight keeping surface needs to have higher precision. For this reason, the cup portion is manufactured by cutting having high processing precision. However, in the cutting, a problem arises in that processing precision is high and cost is high.

In order to handle such a problem, a method of manufacturing the cup portion by casting cheaper than cutting is considered. However, there is a possibility that a cast cavity may occur in the casting. When such a cast cavity occurs in the airtight keeping surface, a problem arises in that the airtightness between the airtight keeping surface and the fuel injection device may be degraded. For this reason, it is not practical to manufacture the cup portion by casting.

Here, an object of the invention is to provide a fuel distribution/supply device capable of realizing a decrease in cost while keeping the airtightness with respect to a fuel injection device.

### Solution to Problem

According to an aspect of the invention, there is provided a fuel distribution/supply device including: a high-pressure fuel storage portion which stores a fuel in a high-pressure state in order to supply the fuel to a plurality of fuel injection devices; and a plurality of cup portions which airtightly keeps each fuel injection device and supplies the fuel stored in the high-pressure fuel storage portion to each fuel injection device, in which the cup portion includes a seal portion which is provided with an airtight keeping surface airtightly keeping each fuel injection device and a cup body which is bonded to the high-pressure fuel storage portion and is provided with a seal portion insertion hole being inserted with the seal portion, and in which the seal portion and the cup body are formed as separate members and are bonded to each other.

In the fuel distribution/supply device according to the aspect of the invention, the seal portion is provided with the airtight keeping surface airtightly keeping the fuel injection device and the seal portion is formed as a member separated from the cup body. Then, the seal portion and the cup body are bonded to each other while the seal portion is inserted into the seal portion insertion hole of the cup body. For this reason, it is possible to manufacture the seal portion and the cup body constituting the cup portion by different processing methods. The cup portion needs to have high dimensional precision with respect to the airtight keeping surface, but does not need high precision like the airtight keeping surface with respect to a surface other than the airtight keeping surface. For this reason, it is possible to manufacture the seal portion by a processing method such as cutting having high dimensional precision and to manufacture the cup body by a processing method such as casting having low cost. Accordingly, it is possible to realize a decrease in cost while keeping the airtightness between the cup portion and the fuel injection device.

As one embodiment, the seal portion may cover the seal portion insertion hole of the cup body. In this way, since the seal portion covers the seal portion insertion hole of the cup body, it is possible to keep the airtightness with respect to the fuel injection device regardless of the state of the cup body. For example, even when a cast cavity occurs in the cup body when the cup body is manufactured by casting, the cast cavity is covered by the seal portion. For this reason, it is possible to prevent the leakage of the fuel caused by the cast cavity.

Further, as one embodiment, the seal portion and the cup body may be formed of different materials. The seal portion keeps the airtightness with respect to the fuel injection device and the cup body keeps the seal portion. For this reason, the performances necessary for the seal portion and the cup body are different. Here, since the seal portion and the cup body are formed of different materials in this way, the seal portion can be manufactured by a material having a characteristic suitable for the seal portion and the cup body can be manufactured by a material having a characteristic suitable for the cup body. Accordingly, it is possible to improve the functions of the seal portion and the cup body.

Further, as one embodiment, at least one of the seal portion and the cup body may be formed of resin. In this way, when at least one of the seal portion and the cup body is formed of resin, it is possible to realize a decrease in weight and cost of the cup portion.

Further, as one embodiment, any one of the seal portion and the cup body may be formed of resin and the other thereof may be formed of metal. Then, the seal portion and the cup body may be bonded to each other by insert-molding. In this way, any one of the seal portion and the cup body is formed of resin and the other thereof is formed of metal. Accordingly, it is possible to ensure strength while keeping a decrease in weight and cost of the cup portion. Further, it is possible to manage the positional precision of the seal portion with respect to a predetermined reference position of the fuel distribution/supply device by resin injection-molding. For this reason, it is possible to suppress the positional deviation of the seal portion with respect to a predetermined reference position of the fuel distribution/supply device.

Further, as one embodiment, the seal portion may be formed of resin. In this way, when the seal portion is formed of resin, it is possible to improve the dimensional precision of the airtight keeping surface.

Further, as one embodiment, the thermal expansion coefficient of the seal portion may be larger than the thermal expansion coefficient of the cup body. In this way, when the thermal expansion coefficient of the seal portion is set to be larger than the thermal expansion coefficient of the cup body, it is possible to prevent the seal portion from being separated from the cup body when the cup portion is heated. For example, it is possible to prevent the seal portion from being separated from the cup body during brazing when the seal portion and the cup body are bonded to each other by brazing.

Further, as one embodiment, the seal portion and the cup body may be formed of metal, the seal portion and the cup body may be bonded to each other by brazing, and the outer peripheral surface of the seal portion may be provided with a notch for providing a brazing material. In this way, when the seal portion and the cup body are bonded to each other by brazing, it is possible to improve the bonding strength of the seal portion and the cup body. Further, since the outer peripheral surface of the seal portion is provided with the notch for providing the brazing material, it is possible to easily provide the brazing material in the seal portion and to suppress the brazing material from flowing to the airtight keeping surface.

### Advantageous Effects of Invention

According to the invention, it is possible to realize a decrease in cost while keeping the airtightness with respect to a fuel injection device.

### BRIEF DESCRIPTION OF DRAWINGS

FIG. 1 is a perspective view of a fuel supply system including a fuel distribution/supply device according to an embodiment;

FIG. 2 is a perspective view of the fuel distribution/supply device of the embodiment;

FIG. 3 is a perspective view of a cup portion;

FIG. 4 is a perspective view of the cup portion;

FIG. 5 is a cross-sectional view taken along the line V-V illustrated in FIG. 3;

FIG. 6 is a diagram illustrating a seal portion, where FIG. 6(a) is a perspective view and FIG. 6(b) is a cross-sectional view taken along the line VI(b)-VI(b) illustrated in FIG. 6(a);

FIG. 7 is a diagram illustrating the cup body, where FIG. 7(a) is a perspective view and FIG. 7(b) is a cross-sectional view taken along the line VII(b)-VII(b) illustrated in FIG. 7(a);

FIG. 8 is a cross-sectional view of a cup portion of a fuel distribution/supply device according to a second embodiment;

FIG. 9 is a cross-sectional view of a cup portion of a fuel distribution/supply device according to a third embodiment;

FIG. 10 is a perspective view of a cup portion of a fuel distribution/supply device according to a fourth embodiment; and

FIG. 11 is a cross-sectional view taken along the line XI-XI illustrated in FIG. 10.

### DESCRIPTION OF EMBODIMENTS

Hereinafter, embodiments of a fuel distribution/supply device according to an embodiment will be described with reference to the drawings. In addition, the same reference numerals will be given to the similar or equivalent components in the drawings and the repetitive description thereof will not be made.

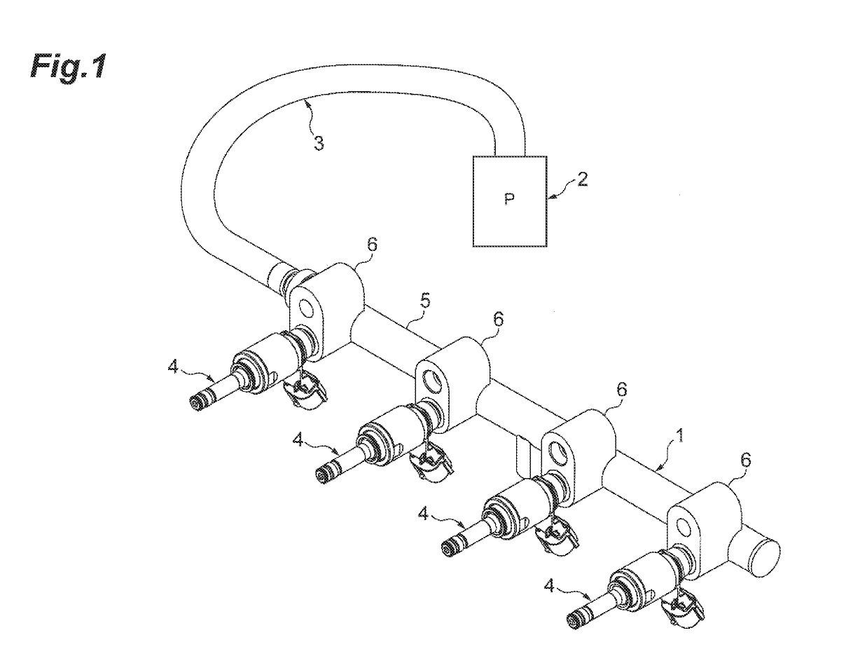

FIG. 1 is a perspective view of a fuel supply system including a fuel distribution/supply device according to the embodiment. As illustrated in FIG. 1, the fuel distribution/supply device 1 according to the embodiment distributes and supplies a fuel pressure-fed from a fuel pump 2 through a joint pipe 3 to a plurality of fuel injection devices 4 injecting a fuel to a plurality of cylinders of an engine (not illustrated). The fuel distribution/supply device 1 illustrated in FIG. 1 distributes and supplies a fuel to four fuel injection devices 4 respectively attached to cylinders of a four-cylinder engine. Here, the number of the fuel injection devices 4 distributing and supplying a fuel is not limited and is appropriately selected according to the type of the engine. In addition, the fuel distribution/supply device 1 is also called a fuel injection rail.

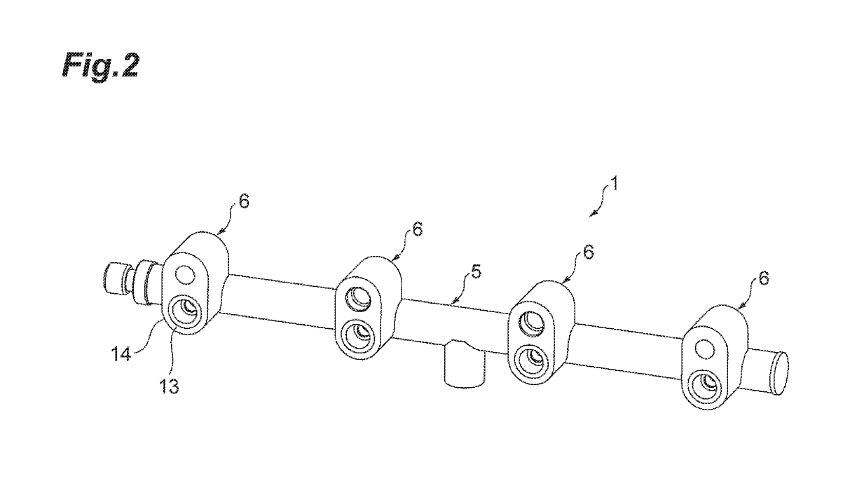

FIG. 2 is a perspective view of the fuel distribution/supply device according to the embodiment. As illustrated in FIGS. 1 and 2, the fuel distribution/supply device 1 mainly includes a high-pressure fuel storage portion 5 and a plurality of cup portions 6.

The high-pressure fuel storage portion 5 stores a fuel pressure-fed from the fuel pump 2 in a high-pressure state in order to supply the fuel to the plurality of fuel injection devices 4. The high-pressure fuel storage portion 5 is formed in a circular pipe shape which extends in the direction of the cylinder bank of the engine (the direction of the crank shaft). In addition, the pipe shape of the high-pressure fuel storage portion 5 may not be the circular pipe shape extending linearly, but may be various shapes. An inner space (not illustrated) communicating with the joint pipe 3 is formed inside the high-pressure fuel storage portion 5. The inner space is a space which stores a fuel pressure-fed from the joint pipe 3 in a high-pressure state. The material of the high-pressure fuel storage portion 5 is not particularly limited and may be, for example, metal or resin. Further, a method of manufacturing the high-pressure fuel storage portion 5 is not particularly limited, the high-pressure fuel storage portion 5 formed of metal may be manufactured by hot forging or the like, and the high-pressure fuel storage portion 5 formed of resin may be manufactured by injection molding. In addition, the high-pressure fuel storage portion 5 temporarily stores a fuel pressure-fed from the fuel pump 2 and suppresses the pulsation of the fuel pump 2 from being transmitted to the fuel injection device 4.

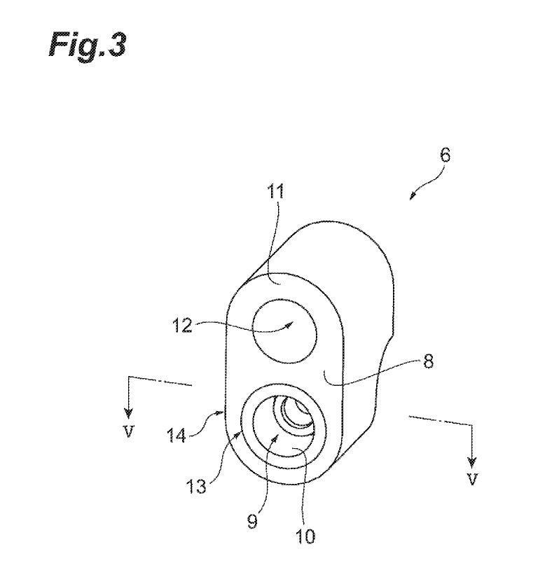

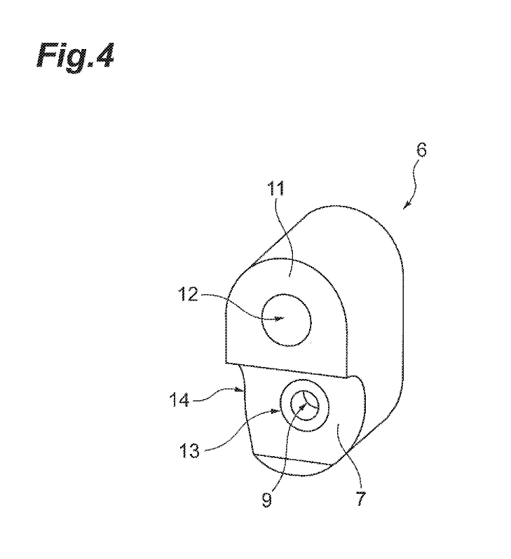

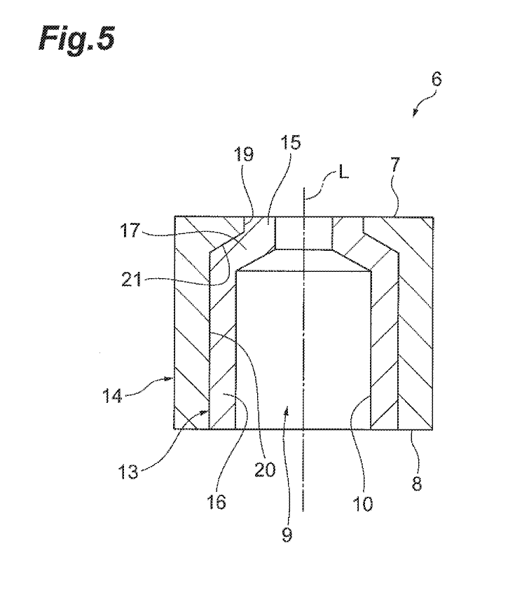

The cup portion 6 airtightly keeps each fuel injection device 4 and supplies a fuel stored in the high-pressure fuel storage portion 5 to each fuel injection device 4. FIGS. 3 and 4 are perspective views of the cup portion. FIG. 5 is a cross-sectional view taken along the line V-V illustrated in FIG. 3. As illustrated in FIGS. 3 to 5, a surface near the high-pressure fuel storage portion 5 in the cup portion 6 is provided with a bonding surface 7 bonded to the high-pressure fuel storage portion 5. The bonding surface 7 is formed in a concave curved shape corresponding to the outer shape of the high-pressure fuel storage portion 5 so as to adhere to the high-pressure fuel storage portion 5. A front end surface 8 of the cup portion 6 opposite the high-pressure fuel storage portion 5 is formed in a plane shape.

The cup portion 6 is provided with a fuel injection device insertion hole 9 which communicates with the inner space of the high-pressure fuel storage portion 5 and is inserted with the fuel injection device 4. Further, in the embodiment, the fuel injection device insertion hole 9 will be described as a through-hole that linearly penetrates the bonding surface 7 and the front end surface 8. However, the fuel injection device insertion hole 9 may not penetrate the cup portion 6 as long as the fuel injection device insertion hole communicates with the inner space of the high-pressure fuel storage portion 5 by a horizontal hole or the like. The fuel injection device insertion hole 9 is a hole which extends linearly. The center axis line L of the fuel injection device insertion hole 9 extends in a direction perpendicular to the front end surface 8. The inner peripheral surface of the fuel injection device insertion hole 9 is provided with an airtight keeping surface 10 which airtightly keeps the fuel injection device 4. The fuel injection device 4 or a seal member such as an O-ring fitted to the fuel injection device 4 comes into contact with the airtight keeping surface 10. Accordingly, the airtightness between the airtight keeping surface 10 and the fuel injection device 4 is kept. For this reason, the airtight keeping surface 10 is formed with high precision involved with a hole diameter, a roughness, a roundness, and the like. Then, when the fuel injection device 4 is airtightly kept by the airtight keeping surface 10 formed in the inner peripheral surface of the fuel injection device insertion hole 9, the cup portion 6 is able to supply the high-pressure fuel stored in the high-pressure fuel storage portion 5 to the fuel injection device 4.

Further, the cup portion 6 is provided with a stay portion 11 which fixes the fuel distribution/supply device 1 to an engine block (not illustrated). The stay portion 11 is provided with a bolt hole 12 through which a bolt (not illustrated) for fixing the fuel distribution/supply device 1 to the engine block is inserted. The bolt hole 12 extends in a direction perpendicular to the front end surface 8. That is, the center axis line of the bolt hole 12 and the center axis line L of the fuel injection device insertion hole 9 are parallel to each other. Further, in the embodiment, a description will be made on the assumption that the stay portion 11 is integrated with the cup portion 6. Here, the stay portion 11 may be separated from the cup portion 6,

Then, the cup portion 6 with such a configuration mainly includes a seal portion 13 and a cup body 14.

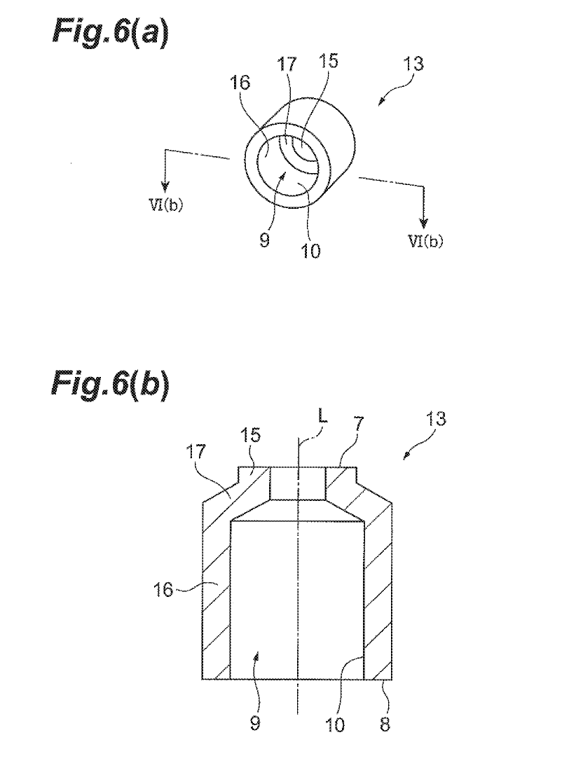

FIG. 6(a) is a perspective view of the seal portion and FIG. 6(b) is a cross-sectional view taken along the line VI (b)-VI (b) illustrated in FIG. 6(a). As illustrated in FIGS. 5 and 6, the seal portion 13 is a member that constitutes the cup portion 6 and is provided with the airtight keeping surface 10 of the cup portion 6. The seal portion 13 is formed as a member separated from the cup body 14. The seal portion 13 is formed in a modified cylindrical shape. The seal portion 13 extends from the bonding surface 7 to the front end surface 8 and the inner peripheral surface of the seal portion 13 is provided with the fuel injection device insertion hole 9 of the cup portion 6. That is, the fuel injection device insertion hole 9 of the cup portion 6 is formed only in the seal portion 13.

Specifically, the seal portion 13 includes a small diameter portion 15 which is disposed near the bonding surface 7, a large diameter portion 16 which is disposed near the front end surface 8, and an enlarged diameter portion 17 which is disposed between the small diameter portion 15 and the large diameter portion 16. The small diameter portion 15, the large diameter portion 16, and the enlarged diameter portion 17 are formed so as to have a circular cross-section about the center axis line L of the fuel injection device insertion hole 9. The thickness of the small diameter portion 15 is substantially equal to the thickness of the large diameter portion 16. The diameter of the large diameter portion 16 is larger than that of the small diameter portion 15 and the diameter of the enlarged diameter portion 17 is enlarged linearly from the small diameter portion 15 to the large diameter portion 16. In addition, the enlarged diameter portion 17 may extend in a direction perpendicular to the center axis line L of the fuel injection device insertion hole 9 while being bent at a right angle with respect to the small diameter portion 15 and the large diameter portion 16. Then, the fuel injection device insertion hole 9 is formed by the inner peripheral surfaces of the small diameter portion 15, the large diameter portion 16, and the enlarged diameter portion 17 and the inner peripheral surface of the large diameter portion 16 is formed as the airtight keeping surface 10.

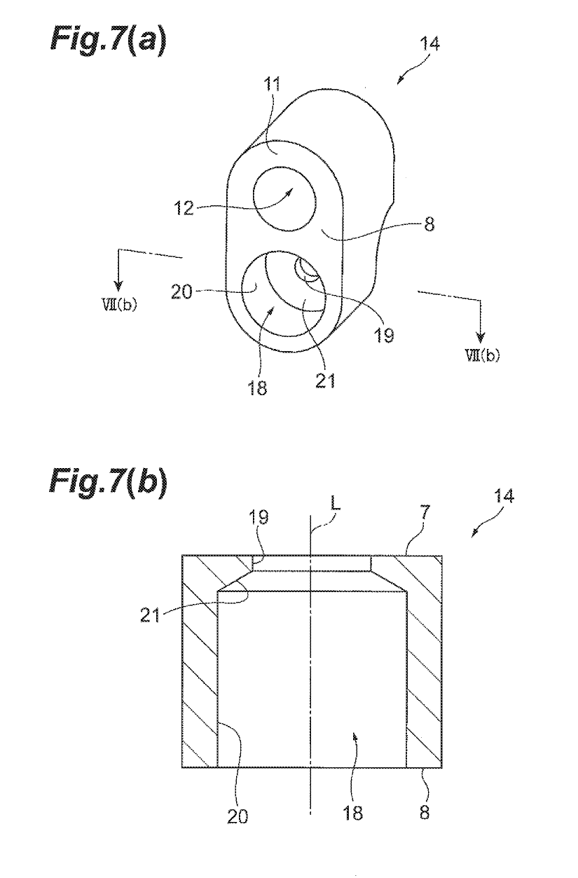

FIG. 7(a) is a perspective view of the cup body and FIG. 7(b) is a cross-sectional view taken along the line VII (b)-VII (b) illustrated in FIG. 7(a). As illustrated in FIGS. 5 and 7, the cup body 14 is a member that constitutes the cup portion 6 and bonded to the high-pressure fuel storage portion 5 so as to keep the seal portion 13. The cup body 14 is formed as a member separated from the seal portion 13. The cup body 14 is provided with a seal portion insertion hole 18 which communicates with the inner space of the high-pressure fuel storage portion 5 and is inserted with the seal portion 13. In addition, in the embodiment, the seal portion insertion hole 18 will be described as a through-hole that penetrates the cup body 14. However, the seal portion insertion hole 18 may not penetrate the cup body 14 as long as the seal portion insertion hole communicates with the inner space of the high-pressure fuel storage portion 5 by a horizontal hole or the like similarly to the fuel injection device insertion hole 9.

Specifically, the seal portion insertion hole 18 is formed by a small diameter inner peripheral surface 19 disposed near the bonding surface 7, a large diameter inner peripheral surface 20 disposed near the front end surface 8, and an enlarged diameter inner peripheral surface 21 disposed between the small diameter inner peripheral surface 19 and the large diameter inner peripheral surface 20. The small diameter inner peripheral surface 19, the large diameter inner peripheral surface 20, and the enlarged diameter inner peripheral surface 21 are formed so as to have a circular cross-section about the center axis line L of the fuel injection device insertion hole 9. Then, the inner diameters of the small diameter inner peripheral surface 19, the large diameter inner peripheral surface 20, and the enlarged diameter inner peripheral surface 21 are substantially equal to those of the small diameter portion 15, the large diameter portion 16, and the enlarged diameter portion 17 of the seal portion 13. That is, the diameter of the large diameter inner peripheral surface 20 is larger than that of the small diameter inner peripheral surface 19 and the enlarged diameter inner peripheral surface 21 is enlarged linearly from the small diameter inner peripheral surface 19 to the large diameter inner peripheral surface 20. In addition, the substantially equal diameter indicates a state where the diameters are substantially equal to each other and also indicates a state where the diameter is slightly large or small other than the equal diameter. Further, the lengths of the small diameter inner peripheral surface 19, the large diameter inner peripheral surface 20, and the enlarged diameter inner peripheral surface 21 in the direction of the center axis line L are substantially equal to the lengths of the small diameter portion 15, the large diameter portion 16, and the enlarged diameter portion 17 of the seal portion 13 in the direction of the center axis line L. For this reason, when the seal portion 13 is inserted into the seal portion insertion hole 18, the outer peripheral surfaces of the small diameter portion 15, the large diameter portion 16, and the enlarged diameter portion 17 of the seal portion 13 adhere to the small diameter inner peripheral surface 19, the large diameter inner peripheral surface 20, and the enlarged diameter inner peripheral surface 21 of the cup body 14. In addition, the substantially equal length indicates a state where the lengths are substantially equal to each other and also indicates a state where the length is slightly long or short other than the equal length.

As described above, since the seal portion 13 and the cup body 14 are formed as separate members, the seal portion 13 and the cup body 14 may be formed of different materials or the same material. As the material for the seal portion 13, any material may be used as long as the characteristic necessary for the seal portion 13 can be obtained. For example, metal such as aluminum or resin such as polyamide (PA) can be used as the material for the seal portion 13. As the material for the cup body 14, any material can be used as long as the characteristic necessary for the cup body 14 can be obtained. For example, metal such as aluminum or resin such as polyamide (PA) can be used as the material for the cup body 14. In addition, when the seal portion 13 is inserted into the seal portion insertion hole 18, the material for the seal portion 13 and the cup body 14 can be set so that the thermal expansion coefficient of the seal portion 13 becomes larger than the thermal expansion coefficient of the cup body 14.

Further, since the seal portion 13 and the cup body 14 are formed as separate members, the seal portion 13 and the cup body 14 may be manufactured by the same manufacturing method or different manufacturing methods. As the manufacturing method for the seal portion 13, any method may be used as long as the characteristic necessary for the seal portion 13 and the airtight keeping surface 10 can be obtained. For example, cutting, hot forging, cold forging, pressing, a combination of cutting and pressing, or resin injection-molding can be used as the manufacturing method for the seal portion 13. As the manufacturing method for the cup body 14, any method may be used as long as the characteristic necessary for the cup body 14 can be obtained. For example, cutting, hot forging, cold forging, pressing, casting, lost wax, metal injection (metal injection-molding), or resin injection-molding can be used as the manufacturing method for the cup body 14.

Then, the cup portion 6 has a configuration in which the cup body 14 and the seal portion 13 are bonded to each other while the seal portion 13 is inserted into the seal portion insertion hole 18. That is, the cup portion 6 has a configuration in which the seal portion 13 and the cup body 14 are bonded to each other while the outer peripheral surfaces of the small diameter portion 15, the large diameter portion 16, and the enlarged diameter portion 17 of the seal portion 13 adhere to the small diameter inner peripheral surface 19, the large diameter inner peripheral surface 20, and the enlarged diameter inner peripheral surface 21 of the cup body 14. For this reason, the seal portion insertion hole 18 is completely covered by the seal portion 13.

As the bonding method for the seal portion 13 and the cup body 14, the bonding method is not particularly limited as long as the seal portion 13 and the cup body 14 can be bonded to each other. For example, when both the seal portion 13 and the cup body 14 are formed of metal, for example, brazing can be used as the bonding method. Further, when the seal portion 13 and the cup body 14 are formed of resin, welding can be used as the bonding method. Further, when one of the seal portion 13 and the cup body 14 is formed of metal and the other thereof is formed of resin, for example, insert-molding or welding can be used as the bonding method. Further, when both the seal portion 13 and the cup body 14 are formed of resin, for example, two-color molding or welding can be used as the bonding method.

Here, a combination of the material and the manufacturing method for the seal portion 13 and the cup body 14 will be described based on the examples (1) to (22).

(1) In the combination example 1, the material for the seal portion 13 and the cup body 14 is set as metal. Further, the manufacturing method for the seal portion 13 and the cup body 14 is set as cutting. In this case, the seal portion 13 and the cup body 14 can be bonded to each other by, for example, brazing.

(2) In the combination example 2, the material for the seal portion 13 and the cup body 14 is set as metal. Further, the manufacturing method for the seal portion 13 is set as pressing and the manufacturing method for the cup body 14 is set as cutting. In this case, the seal portion 13 and the cup body 14 can be bonded to each other by, for example, brazing.

(3) In the combination example 3, the material for the seal portion 13 is set as resin and the material for the cup body 14 is set as metal. Further, the manufacturing method for the seal portion 13 is set as injection-molding and the manufacturing method for the cup body 14 is set as cutting. In this case, the seal portion 13 and the cup body 14 can be bonded to each other by, for example, insert-molding or welding.

(4) In the combination example 4, the material for the seal portion 13 and the cup body 14 is set as metal. Further, the manufacturing method for the seal portion 13 is set as cutting and the manufacturing method for the cup body 14 is set as pressing. In this case, the seal portion 13 and the cup body 14 can be bonded to each other by, for example, brazing.

(5) In the combination example 5, the material for the seal portion 13 and the cup body 14 is set as metal. Further, the manufacturing method for the seal portion 13 and the cup body 14 is set as pressing. In this case, the seal portion 13 and the cup body 14 can be bonded to each other by, for example, brazing.

(6) In the combination example 6, the material for the seal portion 13 is set as resin and the material for the cup body 14 is set as metal. Further, the manufacturing method for the seal portion 13 is set as injection-molding and the manufacturing method for the cup body 14 is set as pressing. In this case, the seal portion 13 and the cup body 14 can be bonded to each other by, for example, insert-molding or welding.

(7) In the combination example 7, the material for the seal portion 13 and the cup body 14 is set as metal. Further, the manufacturing method for the seal portion 13 is set as cutting and the manufacturing method for the cup body 14 is set as casting. In this case, the seal portion 13 and the cup body 14 can be bonded to each other by, for example, brazing.

(8) In the combination example 8, the material for the seal portion 13 and the cup body 14 is set as metal. Further, the manufacturing method for the seal portion 13 is set as pressing and the manufacturing method for the cup body 14 is set as casting. In this case, the seal portion 13 and the cup body 14 can be bonded to each other by, for example, brazing.

(9) In the combination example 9, the material for the seal portion 13 is set as resin and the material for the cup body 14 is set as metal. Further, the manufacturing method for the seal portion 13 is set as injection-molding and the manufacturing method for the cup body 14 is set as casting. In this case, the seal portion 13 and the cup body 14 can be bonded to each other by, for example, insert-molding or welding.

(10) In the combination example 10, the material for the seal portion 13 and the cup body 14 is set as metal. Further, the manufacturing method for the seal portion 13 is set as cutting and the manufacturing method for the cup body 14 is set as metal injection. In this case, the seal portion 13 and the cup body 14 can be bonded to each other by, for example, brazing.

(11) In the combination example 11, the material for the seal portion 13 and the cup body 14 is set as metal. Further, the manufacturing method for the seal portion 13 is set as pressing and the manufacturing method for the cup body 14 is set as metal injection. In this case, the seal portion 13 and the cup body 14 can be bonded to each other by, for example, brazing.

(12) In the combination example 12, the material for the seal portion 13 is set as resin and the material for the cup body 14 is set as metal. Further, the manufacturing method for the seal portion 13 is set as injection-molding and the manufacturing method for the cup body 14 is set as metal injection. In this case, the seal portion 13 and the cup body 14 can be bonded to each other by, for example, insert-molding or welding.

(13) In the combination example 13, the material for the seal portion 13 and the cup body 14 is set as metal. Further, the manufacturing method for the seal portion 13 is set as cutting and the manufacturing method for the cup body 14 is set as hot forging. In this case, the seal portion 13 and the cup body 14 can be bonded to each other by, for example, brazing.

(14) In the combination example 14, the material for the seal portion 13 and the cup body 14 is set as metal. Further, the manufacturing method for the seal portion 13 is set as pressing and the manufacturing method for the cup body 14 is set as hot forging. In this case, the seal portion 13 and the cup body 14 can be bonded to each other by, for example, brazing.

(15) In the combination example 15, the material for the seal portion 13 is set as resin and the material for the cup body 14 is set as metal. Further, the manufacturing method for the seal portion 13 is set as injection-molding and the manufacturing method for the cup body 14 is set as hot forging. In this case, the seal portion 13 and the cup body 14 can be bonded to each other by, for example, insert-molding or welding.

(16) In the combination example 16, the material for the seal portion 13 and the cup body 14 is set as metal. Further, the manufacturing method for the seal portion 13 is set as cutting and the manufacturing method for the cup body 14 is set as cold forging. In this case, the seal portion 13 and the cup body 14 can be bonded to each other by, for example, brazing.

(17) In the combination example 17, the material for the seal portion 13 and the cup body 14 is set as metal. Further, the manufacturing method for the seal portion 13 is set as pressing and the manufacturing method for the cup body 14 is set as cold forging. In this case, the seal portion 13 and the cup body 14 can be bonded to each other by, for example, brazing.

(18) In the combination example 18, the material for the seal portion 13 is set as resin and the material for the cup body 14 is set as metal. Further, the manufacturing method for the seal portion 13 is set as injection-molding and the manufacturing method for the cup body 14 is set as cold forging. In this case, the seal portion 13 and the cup body 14 can be bonded to each other by, for example, insert-molding or welding.

(19) In the combination example 19, the material for the seal portion 13 and the cup body 14 is set as metal. Further, the manufacturing method for the seal portion 13 is set as cutting and the manufacturing method for the cup body 14 is set as lost wax. In this case, the seal portion 13 and the cup body 14 can be bonded to each other by, for example, brazing.

(20) In the combination example 20, the material for the seal portion 13 and the cup body 14 is set as metal. Further, the manufacturing method for the seal portion 13 is set as pressing and the manufacturing method for the cup body 14 is set as lost wax. In this case, the seal portion 13 and the cup body 14 can be bonded to each other by, for example, brazing.

(21) In the combination example 21, the material for the seal portion 13 is set as resin and the material for the cup body 14 is set as metal. Further, the manufacturing method for the seal portion 13 is set as injection-molding and the manufacturing method for the cup body 14 is set as lost wax. In this case, the seal portion 13 and the cup body 14 can be bonded to each other by, for example, insert-molding or welding.

(22) In the combination example 22, the material for the seal portion 13 is set as metal and the material for the cup body 14 is set as resin. Further, the manufacturing method for the seal portion 13 is set as cutting and the manufacturing method for the cup body 14 is set as injection-molding. In this case, the seal portion 13 and the cup body 14 can be bonded to each other by, for example, insert-molding or welding.

(23) In the combination example 23, the material for the seal portion 13 is set as metal and the material for the cup body 14 is set as resin. Further, the manufacturing method for the seal portion 13 is set as pressing and the manufacturing method for the cup body 14 is set as injection-molding. In this case, the seal portion 13 and the cup body 14 can be bonded to each other by, for example, insert-molding or welding.

(24) In the combination example 24, the material for the seal portion 13 and the cup body 14 is set as resin. Further, the manufacturing method for the seal portion 13 and the cup body 14 is set as injection-molding. In this case, the seal portion 13 and the cup body 14 can be bonded to each other by, for example, two-color molding or welding.

In the above-described combinations, when the material for the seal portion 13 is set as metal, it is possible to ensure the sufficient strength of the seal portion 13. When the material for the seal portion 13 is set as resin, it is possible to realize a decrease in weight and cost of the seal portion 13. Similarly, when the material for the cup body 14 is set as metal, it is possible to ensure the sufficient strength of the cup body 14. When the material for the cup body 14 is set as resin, it is possible to realize a decrease in weight and cost of the cup body 14.

When the manufacturing method for the seal portion 13 is set as cutting, it is possible to improve the dimensional precision of the airtight keeping surface 10 while ensuring the mass productivity of the seal portion 13.

When the manufacturing method for the seal portion 13 is set as pressing, the manufacturing cost is decreased compared with a case where the seal portion 13 is manufactured by cutting and the limitation of the plate thickness of the seal portion 13 is alleviated.

When the manufacturing method for the seal portion 13 is set as resin injection-molding, it is possible to manage the positional precision of the seal portion 13 with respect to a predetermined reference position of the fuel distribution/supply device 1 by the resin injection-molding of the seal portion 13. For this reason, it is possible to suppress the positional deviation of the seal portion 13 with respect to a predetermined reference position of the fuel distribution/supply device 1.

When the manufacturing method for the cup body 14 is set as cutting, the dimensional precision of the cup body 14 may be lower than that of the seal portion 13. For this reason, the manufacturing cost is decreased compared with a case where the seal portion 13 and the cup body 14 are integrally cut and the mass productivity of the seal portion 13 can be ensured.

When the manufacturing method for the cup body 14 is set as pressing, the manufacturing cost is decreased compared with a case where the cup body 14 is manufactured by cutting and the limitation of the plate thickness of the cup body 14 is alleviated.

When the manufacturing method for the cup body 14 is set as casting, the manufacturing cost is decreased compared with a case where the cup body 14 is manufactured by cutting.

When the manufacturing method for the cup body 14 is set as metal injection, the manufacturing cost is decreased compared with a case where the cup body 14 is manufactured by cutting.

When the manufacturing method for the cup body 14 is set as hot forging, the manufacturing cost is decreased compared with a case where the cup body 14 is manufactured by cutting.

When the manufacturing method for the cup body 14 is set as cold forging, the manufacturing cost is decreased compared with a case where the cup body 14 is manufactured by cutting.

When the manufacturing method for the cup body 14 is set as lost wax, the manufacturing cost is decreased compared with a case where the cup body 14 is manufactured by cutting.

When the manufacturing method for the cup body 14 is set as resin injection-molding, it is possible to manage the positional precision of the seal portion 13 with respect to a predetermined reference position of the fuel distribution/supply device 1 by the resin injection-molding of the cup body 14. For this reason, it is possible to suppress the positional deviation of the seal portion 13 with respect to a predetermined reference position of the fuel distribution/supply device 1.

As described above, according to the fuel distribution/supply device 1 of the embodiment, the seal portion 13 is provided with the airtight keeping surface 10 which airtightly keeps the fuel injection device 4 and the seal portion 13 is formed as a member separated from the cup body 14. Then, the seal portion 13 and the cup body 14 are bonded to each other while the seal portion 13 is inserted into the seal portion insertion hole 18. For this reason, the seal portion 13 and the cup body 14 constituting the cup portion 6 can be manufactured by different processing methods. The cup portion 6 needs to have high dimensional precision with respect to the airtight keeping surface 10, but does not need high precision like the airtight keeping surface 10 with respect to a surface other than the airtight keeping surface 10. For this reason, it is possible to manufacture the seal portion 13 by a processing method such as cutting having high dimensional precision and to manufacture the cup body 14 by a processing method such as casting having low cost. Accordingly, it is possible to realize a decrease in cost while keeping the airtightness between the cup portion 6 and the fuel injection device 4.

Further, since the seal portion 13 covers the entire seal portion insertion hole 18, it is possible to keep the airtightness with respect to the fuel injection device 4 regardless of the state of the cup body 14. For example, even when a cast cavity occurs in the cup body 14 when the cup body 14 is manufactured by casting, the cast cavity is covered by the seal portion 13. For this reason, it is possible to prevent the leakage of the fuel caused by the cast cavity.

Further, the seal portion 13 keeps the airtightness with respect to the fuel injection device 4 and the cup body 14 keeps the seal portion 13. For this reason, the performances necessary for the seal portion 13 and the cup body 14 are different. Here, when the seal portion 13 and the cup body 14 are formed of different materials, the seal portion 13 can be formed of a material having a characteristic necessary for the seal portion and the cup body 14 can be formed of a material having a characteristic suitable for the cup body 14. Accordingly, it is possible to improve the functions of the seal portion 13 and the cup body 14.

Further, when at least one of the seal portion 13 and the cup body 14 is formed of resin, it is possible to realize a decrease in weight and cost of the cup portion 6.

Further, any one of the seal portion 13 and the cup body 14 is formed of resin and the other thereof is formed of metal. Accordingly, it is possible to ensure strength while realizing a decrease in weight and cost of the cup portion 6. Further, it is possible to manage the positional precision of the seal portion 13 with respect to a predetermined reference position of the fuel distribution/supply device 1 by resin injection-molding. For this reason, it is possible to suppress the positional deviation of the seal portion 13 with respect to a predetermined reference position of the fuel distribution/supply device 1. In this case, since the seal portion 13 is formed of resin, it is possible to further suppress the positional deviation of the seal portion 13 with respect to a predetermined reference position of the fuel distribution/supply device 1.

Further, when the thermal expansion coefficient of the seal portion 13 is set to be larger than the thermal expansion coefficient of the cup body 14, it is possible to prevent the seal portion 13 from being separated from the cup body 14 when the cup portion 6 is heated. For example, when the seal portion 13 and the cup body 14 are bonded to each other by brazing, it is possible to prevent the seal portion 13 from being separated from the cup body 14 during the brazing.

Further, when the seal portion 13 and the cup body 14 are formed of metal, the bonding strength between the seal portion 13 and the cup body 14 can be improved in a manner such that the seal portion 13 and the cup body 14 are bonded to each other by brazing.

### Second Embodiment

Next, a second embodiment will be described. The second embodiment is basically similar to the first embodiment and is different from the first embodiment only in the shape of the cup portion. For this reason, in the description below, only the difference from the first embodiment will be described and the description similar to the first embodiment will be omitted.

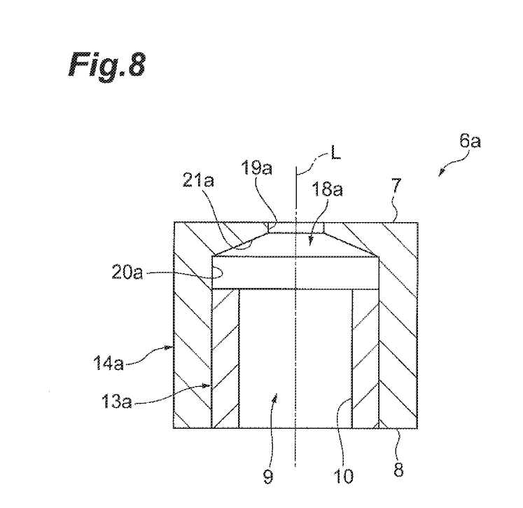

FIG. 8 is a cross-sectional view of a cup portion of a fuel distribution/supply device according to the second embodiment. In addition, FIG. 8 illustrates a cross-sectional view at the same position as FIG. 5. As illustrated in FIG. 8, in the second embodiment, a cup portion 6a corresponding to the cup portion 6 of the first embodiment is provided.

The cup portion 6a includes a seal portion 13a which corresponds to the seal portion 13 of the first embodiment and a cup body 14a which corresponds to the cup body 14 of the first embodiment.

The seal portion 13a is a member that constitutes the cup portion 6a and is provided with the airtight keeping surface 10 of the cup portion 6a. The seal portion 13a is formed as a member separated from the cup body 14a. The seal portion 13a is formed in a cylindrical shape about the center axis line L of the fuel injection device insertion hole 9. The seal portion 13a extends from the bonding surface 7 to the front side of the front end surface 8 and the inner peripheral surface of the seal portion 13a is provided with the fuel injection device insertion hole 9 of the cup portion 6a. That is, the seal portion 13a is provided with a part of the fuel injection device insertion hole 9. Then, the inner peripheral surface of the seal portion 13a is formed as the airtight keeping surface 10.

The cup body 14a is a member that constitutes the cup portion 6 and keeps the seal portion 13a while being bonded to the high-pressure fuel storage portion 5. The cup body 14a is formed as a member separated from the seal portion 13a. The cup body 14a is provided with a seal portion insertion hole 18a into which the seal portion 13a is inserted. In the embodiment, a description will be made on the assumption that the seal portion insertion hole 18a is a through-hole which penetrates the cup body 14a. Here, the seal portion insertion hole 18a may not penetrate the cup body 14a as long as the seal portion insertion hole communicates with the inner space of the high-pressure fuel storage portion 5 by a horizontal hole or the like similarly to the fuel injection device insertion hole 9. The seal portion insertion hole 18a is formed by a small diameter inner peripheral surface 19a disposed near the bonding surface 7, a large diameter inner peripheral surface 20a disposed near the front end surface 8, and an enlarged diameter inner peripheral surface 21a disposed between the small diameter inner peripheral surface 19a and the large diameter inner peripheral surface 20a. The small diameter inner peripheral surface 19a, the large diameter inner peripheral surface 20a, and the enlarged diameter inner peripheral surface 21a are formed so as to have a circular cross-section about the center axis line L of the fuel injection device insertion hole 9. Then, the inner diameter of the small diameter inner peripheral surface 19a is substantially equal to the inner diameter of the small diameter portion 15 of the seal portion 13 of the first embodiment, the inner diameter of the large diameter inner peripheral surface 20a is substantially equal to the outer diameter of the seal portion 13a, and the enlarged diameter inner peripheral surface 21a is enlarged linearly from the small diameter inner peripheral surface 19a to the large diameter inner peripheral surface 20a. In addition, the enlarged diameter inner peripheral surface 21a may extend in a direction perpendicular to the center axis line L of the fuel injection device insertion hole 9 while being bent at a right angle with respect to the small diameter inner peripheral surface 19a and the large diameter inner peripheral surface 20a.

Then, the cup portion 6a has a configuration in which the cup body 14a and the seal portion 13a are bonded to each other while the seal portion 13a is inserted into the seal portion insertion hole 18a. That is, the cup portion 6a has a configuration in which the seal portion 13a and the cup body 14a are bonded to each other while the outer peripheral surface of the seal portion 13a adheres to the large diameter inner peripheral surface 20a of the cup body 14a. For this reason, only a part of the seal portion insertion hole 18a is covered by the seal portion 13a.

In this way, even when only a part of the seal portion insertion hole 18a is covered by the seal portion 13a, it is possible to obtain the same operation and effect as the first embodiment in a manner such that the seal portion 13a provided with the airtight keeping surface 10 and the cup body 14a are formed as separate members and are bonded to each other.

### Third Embodiment

Next, a third embodiment will be described. The third embodiment is basically similar to the second embodiment and is different from the second embodiment only in the shape of the seal portion. For this reason, in the description below, only the difference from the second embodiment will be described and the description similar to the second embodiment will be omitted.

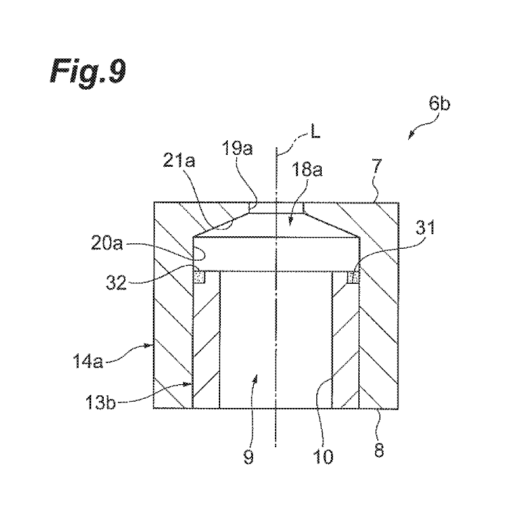

FIG. 9 is a cross-sectional view of a cup portion of a fuel distribution/supply device according to the third embodiment. In addition, FIG. 9 illustrates a cross-sectional view at the same position as FIG. 5. As illustrated in FIG. 9, in the third embodiment, a cup portion 6b corresponding to the cup portion 6a of the second embodiment is provided. The cup portion 6b includes a seal portion 13b corresponding to the seal portion 13a of the second embodiment and the same cup body 14a as the second embodiment.

The seal portion 13b is basically similar to the seal portion 13a of the second embodiment, but the front end near the bonding surface 7 is provided with a notch 31 for providing a brazing material 32. The notch 31 is formed in the entire area of the seal portion 13b in the circumferential direction at the outer peripheral surface side of the seal portion 13b. For this reason, the annular brazing material 32 is easily provided in the notch 31. In addition, the cross-sectional shape of the notch 31 is not particularly limited and can be, for example, a rectangular shape.

In this way, when the outer peripheral surface of the seal portion 13b is provided with the notch 31 for providing the brazing material 32, it is possible to easily provide the brazing material 32 in the seal portion 13b and to suppress the brazing material 32 from flowing to the airtight keeping surface 10.

### Fourth Embodiment

Next, a fourth embodiment will be described. The fourth embodiment is basically similar to the second embodiment and is different from the second embodiment only in the shape of the cup portion. For this reason, in the description below, only the difference from the second embodiment will be described and the description similar to the second embodiment will be omitted.

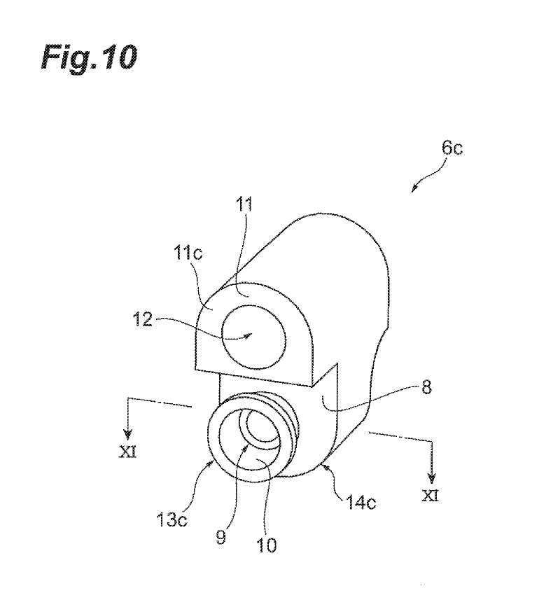

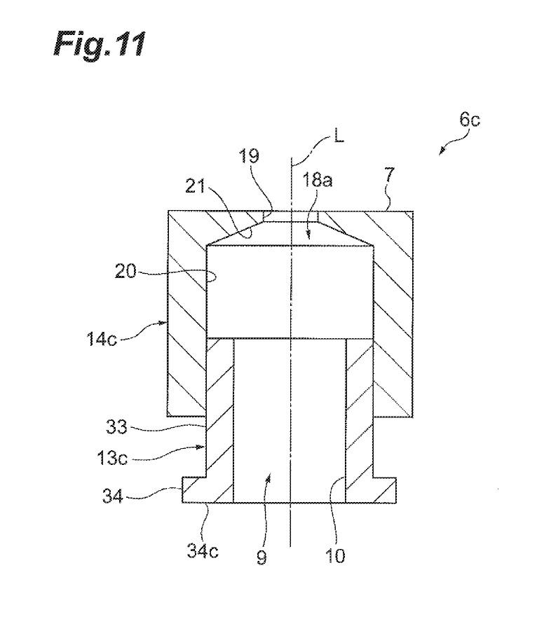

FIG. 10 is a perspective view of a cup portion of a fuel distribution/supply device according to a fourth embodiment. FIG. 11 is a cross-sectional view taken along the line XI-XI illustrated in FIG. 10. As illustrated in FIGS. 10 and 11, in the fourth embodiment, a cup portion 6c corresponding to the cup portion 6a of the second embodiment is provided. The cup portion 6c includes a seal portion 13c which corresponds to the seal portion 13a of the second embodiment and a cup body 14c which corresponds to the cup body 14a of the second embodiment.

Although the cup body 14c is basically similar to the cup body 14a of the second embodiment, the stay portion 11 protrudes from the front end surface 8 of the cup portion 6c. The front end surface 11c of the stay portion 11 is formed as a surface perpendicular to the center axis line L of the fuel injection device insertion hole 9, that is, a surface parallel to the front end surface 8 of the cup body 14c. Similarly to the first embodiment, in the embodiment, a description will be made on the assumption that the stay portion 11 is integrated with the cup portion 6c, but the stay portion 11 may be separated from the cup portion 6c.

The seal portion 13c includes a cylindrical portion 33 similarly to the seal portion 13a of the second embodiment and a flange portion 34. The flange portion 34 radially protrudes outward in the radial direction from the front end of the cylindrical portion 33. The front end surface 34c of the flange portion 34 is formed as a surface perpendicular to the center axis line L of the fuel injection device insertion hole 9, that is, a surface parallel to the front end surface 8 of the cup body 14c and the front end surface 11c of the stay portion 11.

Then, in the cup portion 6c, a part of the cylindrical portion 33 of the seal portion 13c is inserted into the seal portion insertion hole 18a of the cup body 14c and the cup body 14c and the seal portion 13c are bonded to each other while a part of the cylindrical portion 33 and the flange portion 34 protrude from the cup body 14 and the front end surface 34c of the flange portion 34 and the front end surface 11c of the stay portion 11 are disposed on the same plane.

In this way, even when the stay portion 11 protrudes from the front end surface 8 of the cup portion 6c, it is possible to dispose the front end surface 34c of the flange portion 34 and the front end surface 11c of the stay portion 11 on the same plane by bonding the seal portion 13c and the cup body 14c to each other while the flange portion 34 is formed in the seal portion 13c and the seal portion 13c protrudes from the cup body 14. Accordingly, it is possible to improve the attachability to the engine and the fuel injection device 4 while suppressing an increase in cost.

While preferred embodiments of the invention have been described, the invention is not limited to the above-described embodiments.

For example, the first to fourth embodiments may be appropriately combined with one another. For example, the notch formed in the seal portion of the third embodiment may be formed in the seal portion of the first and fourth embodiments and the flange portion formed in the seal portion of the fourth embodiment may be formed in the seal portion of the first to third embodiments.

In addition, the specific shape of the fuel distribution/supply device is illustrated in the drawings, but the fuel distribution/supply device is not limited to such a shape and may be appropriately modified in response to the type of the engine and the like. In addition, the type of the engine may be, for example, a series type, a V-type, or a horizontal opposed type.

### REFERENCE SIGNS LIST

1: fuel distribution/supply device, 2: fuel pump, 3: joint pipe, 4: fuel injection device, 5: high-pressure fuel storage portion, 6: cup portion, 6a: cup portion, 6b: cup portion, 6c: cup portion, 7: bonding surface, 8: front end surface, 9: fuel injection device insertion hole, 10: airtight keeping surface, 11: stay portion, 11c: front end surface, 12: bolt hole, 13: seal portion, 13a: seal portion, 13b: seal portion, 13c: seal portion, 14: cup body, 14a: cup body, 14c: cup body, 15: small diameter portion, 16: large diameter portion, 17: enlarged diameter portion, 18: seal portion insertion hole, 18a: seal portion insertion hole, 19: small diameter inner peripheral surface, 19a: small diameter inner peripheral surface, 20: large diameter inner peripheral surface, 20a: large diameter inner peripheral surface, 21: enlarged diameter inner peripheral surface, 21a: enlarged diameter inner peripheral surface, 32: brazing material, 33: cylindrical portion, 34: flange portion, 34c: front end surface, L: center axis line

1. A fuel distribution/supply device comprising:
a circular pipe-shaped high-pressure fuel storage portion which stores a fuel in an inner space in a high-pressure state in order to supply the fuel to a plurality of fuel injection devices; and
a plurality of cup portions each of which includes a concave curved bonding surface bonded to the high-pressure fuel storage portion and a fuel injection device insertion hole communicating with the inner space of the high-pressure fuel storage portion from the bonding surface and being inserted with each fuel injection device,
wherein the cup portion includes a seal portion which is provided with an airtight keeping surface airtightly keeping each fuel injection device in the fuel injection device insertion hole and a cup body which is bonded to the high-pressure fuel storage portion and is provided with a seal portion insertion hole being inserted with the seal portion, and
wherein the seal portion and the cup body are formed as separate members and are bonded to each other.

2. The fuel distribution/supply device according to claim 1,
wherein the seal portion insertion hole includes
a small diameter inner peripheral surface which is disposed near the bonding surface,
a large diameter inner peripheral surface which is disposed near a front end surface of the cup portion opposite the bonding surface and has a diameter larger than the small diameter inner peripheral surface, and
an enlarged diameter inner peripheral surface which is disposed between the small diameter inner peripheral surface and the large diameter inner peripheral surface and is enlarged from the small diameter inner peripheral surface toward the large diameter inner peripheral surface.

3. The fuel distribution/supply device according to claim 2,
wherein the seal portion extends from the bonding surface to the front end surface and covers a part of the large diameter inner peripheral surface.

4. The fuel distribution/supply device according to claim 2,
wherein the seal portion covers the entire surfaces of the small diameter inner peripheral surface, the large diameter inner peripheral surface, and the enlarged diameter inner peripheral surface.

5. The fuel distribution/supply device according to claim 2,
wherein the seal portion is formed so that a notch is formed in an outer peripheral surface near the bonding surface, and
wherein a brazing material is provided in the notch.

6. The fuel distribution/supply device according to claim 1,
wherein the seal portion includes a cylindrical portion which is inserted into the seal portion insertion hole and a flange portion which protrudes outward in the radial direction from a front end of the cylindrical portion, and
wherein a part of the cylindrical portion and the flange portion protrude from the seal portion insertion hole.

7. The fuel distribution/supply device according to claim 1,
wherein the seal portion and the cup body are formed of different materials.

8. The fuel distribution/supply device according to claim 1,
wherein at least one of the seal portion and the cup body is formed of resin.

9. The fuel distribution/supply device according to claim 1,
wherein any one of the seal portion and the cup body is formed of resin and the other thereof is formed of metal, and
wherein the seal portion and the cup body are bonded to each other by insert-molding.

10. The fuel distribution/supply device according to claim 1,
wherein the seal portion is formed of resin.

11. The fuel distribution/supply device according to claim 1,
wherein a thermal expansion coefficient of the seal portion is larger than that of the cup body.

12. The fuel distribution/supply device according to claim 1,
wherein the seal portion and the cup body are formed of metal,
wherein the seal portion and the cup body are bonded to each other by brazing, and
wherein an outer peripheral surface of the seal portion is provided with a notch for providing a brazing material.
